(19) United States
(12) Patent Application Publication
(10) Pub. No.: US 2001/0042820 A1
(43) Pub. Date: Nov. 22, 2001

(54) Optoelectronic system for an automatic vehicle door closure

(76) Inventor: Robert H. Wilson, Farmington Hills, MI (US)

Correspondence Address: Matthew R. Mowers, Brooks & Kushman P.C., 22nd Floor, 1000 Town Center, Southfield, MI, 48075-1351, US

(21) Appl. No.: 09/751,029

(22) Filed: Dec. 29, 2000

Related U.S. Application Data
(60) Provisional application No. 60/174,434, filed on Jan. 4, 2000.

(51) Int. Cl. H01J 40/14

(52) U.S. Cl. 250/221

(57) ABSTRACT

A non-contact optoelectronic system for an automatic vehicle door closure to detect the presence of an obstruction and a method of detecting the presence of the obstruction. The non-contact optoelectronic system includes at least one transmitter for emitting an electromagnetic energy signal and at least one sensor for detecting the electromagnetic energy signal emitted by the at least one transmitter. A control module in communication with the at least one transmitter and at least one sensor monitors and processes the signal interrupts detected by the at least one sensor to sense an obstruction between the at least one transmitter and at least one sensor. The control module generates a motor control signal to stop and open a vehicle door upon detection of an obstruction between the at least one transmitter and at least one sensor.

### CROSS-REFERENCE TO RELATED APPLICATIONS

This application claims the benefit of U.S. provisional application Serial No. 60/174,434 filed Jan. 4, 2000.

### BACKGROUND OF THE INVENTION

1. Field of the Invention

The present invention relates to a non-contact optoelectronic system for an automatic vehicle door closure and more particularly to an infrared anti-pinch system for sensing obstructions between a closing vehicle door and a door jamb.

2. Background Art

Certain modern minivans and other vehicles are equipped with automatic sliding doors. The automatic sliding doors include a “one-touch” closing feature, wherein a single touch of a control button on the vehicle door or instrument panel actuates the motor assembly to automatically close the door. These minivans typically include an obstruction detection system, which senses the presence of an object in the path of the automatic vehicle door. The obstruction detection system is coupled to a motor control device which sends a signal to the door motor drive to cease the automatic forward progress, and, in some cases, reverse the direction of the door to allow an operator to remove the obstruction from the door path.

One known obstruction detection system senses an obstruction between the closing door and the door jamb by sensing current surges in the drive motor. The system generates a door position signal for a predetermined distance of door movement to measure door speed. The system establishes an obstruction by measuring the stall time of the drive motor. For example, if a toy is caught between the door and the door jamb, the drive motor current will surge as the toy is engaged, and this current surge will be detected by a control module, which signals the door to open. A problem with this type of system is that the sensing of a motor surge requires that a certain amount of force be applied to the pinched object, which may cause serious trauma to an individual even though the door is eventually reversed.

An alternative obstruction detection system for a van door closure system includes a pressure sensor coupled to one or both edges of the vehicle door and door jamb to sense the presence of an object adjacent the door or door jamb. A typical pressure sensor system includes an elongated electrical cable or mechanism having a pair of wires disposed within the cable. As the door or door jamb encounters an obstacle, the wires in the cable are brought into contact, sending a signal to the motor control to stop the forward progress of the motor and to reverse the direction of the door. Similarly to the current detection system, the pressure sensor obstruction detection system requires a certain amount of force be applied to the pinched object causing serious trauma to an individual or object.

Accordingly, it is desirable to provide a non-contact optoelectronic system for a van door closure and a method of preventing pinching by an automatic sliding vehicle door that does not incorporate a mechanical or electromchanical sensing mechanism which contacts the obstruction prior to reversing direction.

### SUMMARY OF THE INVENTION

Therefore, it is an object of the invention is to provide a non-contact optoelectronic system for an automatic vehicle door closure which prevents an object from becoming trapped between the vehicle door and the door jamb.

Another object of the invention is to provide a non-contact optoelectronic system for an automatic vehicle door closure using optical wave transmitters and sensors coupled to a control module to prevents the obstruction from being lodged between the door and door jamb.

A further object of the invention is to provide a non-contact optoelectronic system for an automatic vehicle door closure and a door jamb using an optical wave transmitter and sensor in combination with a reflective material disposed on the door and door jamb coupled to a control module to prevent an object from becoming trapped between the vehicle door and the door jamb.

Yet another object of the invention is to provide a method of detecting an obstruction between a door and door jamb which does not require contact between the obstruction and the door or door jamb.

The present invention overcomes the above-referenced shortcomings of prior art automatic sliding door assemblies by providing a non-contact optoelectronic system for an automatic vehicle door closure and a method of detecting an obstruction in an automatic vehicle door closure system. The non-contact optoelectronic system comprises at least one transmitter for transmitting an electromagnetic energy signal and at least one sensor for detecting the electromagnetic energy signal during the automatic closing of the vehicle door. A control module is in communication with the at least one transmitter and at least one sensor and receives a signal from the at least one sensor. A control module processes the signal from the at least one sensor and generates a motor control signal to stop and reverse the vehicle door upon detection of an obstruction between the at least one transmitter and at least one sensor.

In a first embodiment of the invention, the non-contact optoelectronic system includes a pair of transmitters disposed on an inner surface of a vehicle door which emit an electromagnetic energy interrupt signal, such as an infrared light signal. A plurality of array of sensors are mounted on an inner surface of a door jamb of a vehicle to detect the electromagnetic energy signals emitted by the transmitters. A control module in communication with the transmitters and the sensors activates the transmitters and sensors upon receiving a signal from a switching mechanism to close the automatic vehicle door. The control module sends a signal to the drive motor to move the automatic vehicle door into position.

The control module monitors the signal interrupts detected by the sensors to sense an obstruction between the door and the door jamb during the forward travel of the vehicle door. The control module processes the signals received from the array of sensors and compares the interrupts detected by the sensors against stored values to determine whether an obstruction is present between the door and door jamb. If an obstruction is detected between the vehicle door and door jamb, the control module transmits a signal to a drive motor to open the vehicle door and return the door to a manual operating mode.

In a second embodiment of the invention, the non-contact optoelectronic system includes a transmitter disposed on an inner surface of a vehicle door which emits an electromagnetic energy interrupt signal, such as an infrared light signal. A plurality or array of sensors are mounted on an inner surface of a door jamb of a vehicle to detect the signal emitted by the transmitter. Alternatively, a single sensor may be mounted to an inner surface of the door jamb to detect the signals emitted by the transmitter.

A first reflective surface is disposed on an inner surface of the vehicle door and a second reflective surface is disposed on an inner surface of the door jamb. The reflective surfaces allow the electromagnetic energy signal emitted by the transmitter to reflect between the vehicle door and door jamb. Reflective surfaces may be polished portions of the substrate of the door and door jamb, a reflective coating applied to the inner surfaces of door and doorjamb, or a polished metal foils disposed on the door and door jamb.

A control module in communication with the transmitter and the array of sensors monitors the signal interrupts detected by the sensors to sense an obstruction between the door and the door jamb during the forward travel of the vehicle door. The control module processes the signals against stored comparison values to determine whether an obstruction appears between the door and door jamb. If an obstruction is detected between the vehicle door and door jamb, the control module transmits a signal to a drive motor to reverse the vehicle door travel and return the door to a manual operating mode.

A method of detecting an obstruction for an automatic vehicle door closure systems is also disclosed. A non-contact optoelectronic system is provided to monitor an area between the door and door jamb. The non-contact optoelectronic system includes at least one transmitter disposed on an inner surface of the vehicle door to transmit an electromagnetic energy signal and at least one sensor mounted on an inner surface of the door jamb to detect the electromagnetic energy signal. The at least one sensor transmits the received electromagnetic energy signal to a control module in communication with the at least one transmitter and at least one sensor.

A control module monitors electromagnetic energy interrupt signals detected by at least one sensor. The control module processes the signal by comparing the interrupts generated by the at least one sensor to stored values to detect the presence of an obstruction between the door and door jamb. If an obstruction is detected, the control module transmits a signal to the drive motor to open the automatic door. The method further comprises a hardware fault detection system which sends a pulse of infrared light from the at least one transmitter to the at least one sensor to test the non-contact optoelectronic system during the rearward travel or opening of the automatic vehicle door closure system.

The above objects and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is front plan view of an automatic vehicle door closure assembly including the non-contact optoelectronic system of the present invention;

FIG. 2 is a schematic view of a first embodiment of the non-contact optoelectronic system of the present invention;

FIG. 3 is a schematic view of a second embodiment of the non-contact optoelectronic system in accordance with the present invention; and

FIG. 4 is a block diagram of the method of detecting an obstruction in an automatic vehicle door closure system of the present invention.

### DETAILED DESCRIPTION OF THE PREFERRED EMBODIMENT(S)

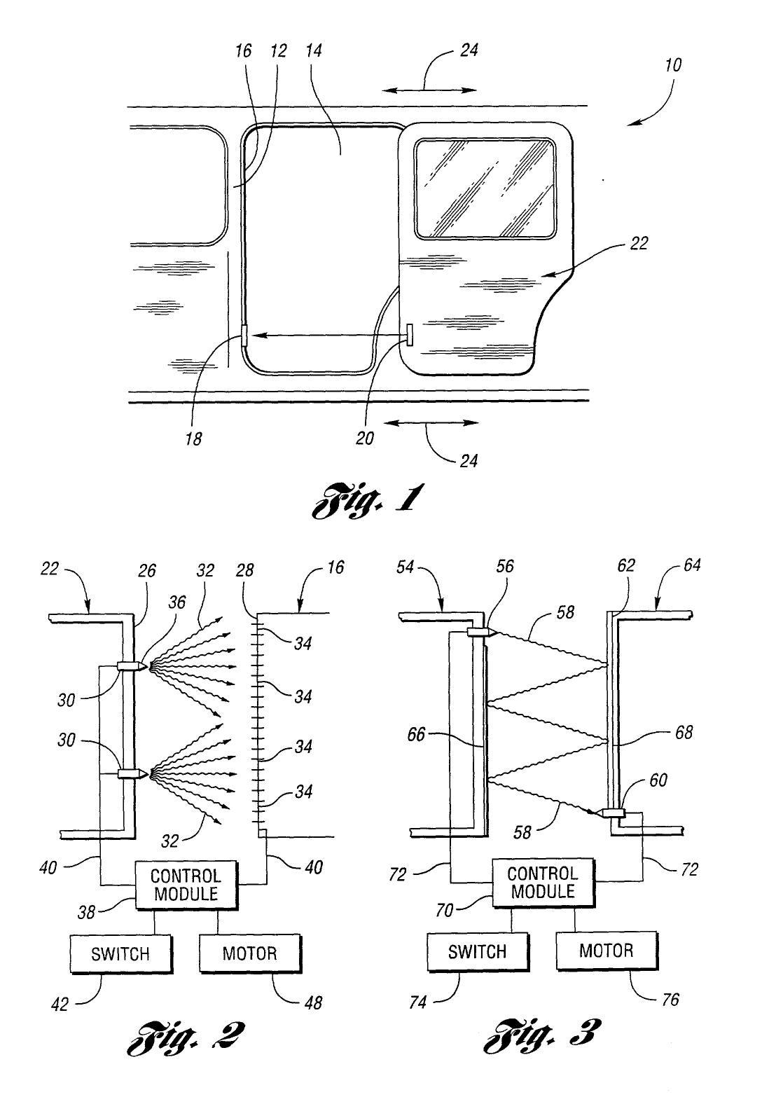

Referring now to the Figures, an automatic vehicle door closure having a non-contact optoelectronic system is disclosed. As is shown in FIG. 1, a vehicle 10 includes a vehicle body 12 including a entry area or passage 14 leading to an interior passenger compartment of the vehicle 10. A door jamb 16 extends about the inner periphery of passage 14 in vehicle body 12. The door jamb 16 includes a striker, shown generally as numeral 18, which is received by a latch 20 mounted on a sliding vehicle door 22. Vehicle door 22 is horizontally adjustable, as is represented by numeral 24, between an open position and a closed position adjacent passage 14 to allow occupants access to and from the passenger compartment of the vehicle. Latch 20 engages striker 18 on door jamb 16 to secure sliding vehicle door 22 in position adjacent passage 14 in vehicle body 12. A motor is coupled to the vehicle door 22 to automatically close the door upon activation of a switch by the operator.

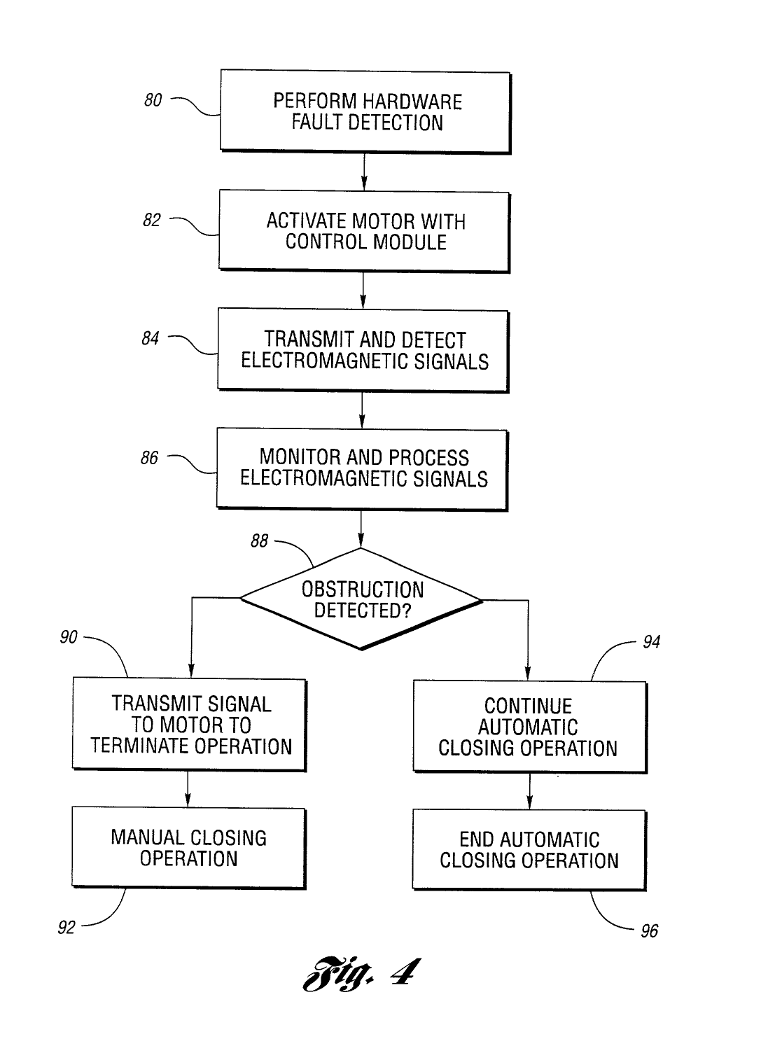

Referring now to FIGS. 2 and 3, a non-contact optoelectronic system of the present invention is described in greater detail. Non-contact optoelectronic system is disposed on the inner surface 26 of sliding vehicle door 22 and the inner surface 28 of door jamb 16 to ensure that an obstruction, such as a limb of an occupant or object, is not trapped or lodged between the door 22 and jamb 16 during the automatic door closing. Non-contact optoelectronic system includes at least one transmitter for emitting an electromagnetic energy signal and at least one sensor for detecting the electromagnetic energy signal emitted by the at least one transmitter. The at least one transmitter is disposed on the inner surface 26 of the vehicle door 22. The at least one transmitter emits an electromagnetic energy signal 32 towards the door jamb 16. At least one sensor is mounted on the inner surface 28 of door jamb 16 and detects signals from the at least one transmitter. It is also understood that transmitters may be disposed on the inner surface 28 of door jamb 16 while sensors are mounted on the inner surface 26 of vehicle door 22 to provide an alternative arrangement for non-contact optoelectronic system 24.

A control module is provided in communication with the at least one transmitter and at least one sensor for monitoring the electromagnetic energy signal interrupts detected by the at least one sensor. The control module processes the electromagnetic energy signals to sense an obstruction between the at least one transmitter on the vehicle door 22 and the at least one sensor on the inner surface of the door jamb 16. The control module generates a motor control signal to open the vehicle door 22 upon detection of an obstruction between the at least one transmitter and at least one sensor.

Referring now to FIG. 2, a first embodiment of the non-contact optoelectronic system of the present invention is shown. Non-contact optoelectronic system 24 includes a pair of transmitters 30 mounted in the sliding vehicle door 22. Each transmitter 30 includes a transmitting portion 36 extending outward of or through an aperture in the inner surface 26 of door 22. Each transmitting portion 36 emits a signal 32 towards the door jamb 16. A plurality of sensors 34 are positioned in an array on the inner surface 28 of door jamb 16 to detect the signal 32 emitted from transmitters 30. The plurality of sensors 34 are preferably mounted on the inner surface 28 of door jamb 16 as an array to provide a broad spectrum of detection for signals 32 emitted by transmitters 30.

By way of example, the transmitters 30 may emit electromagnetic energy signals such as infrared light signal interrupts in the form of square waves having 1 KHz wavelength. Alternatively, an ultrasound wave could be implemented to generate the signal interrupts detected by sensors 34. The plurality or array of sensors 34 detect the infrared light 32 to determine the wavelength of the detected infrared light to develop an interrupt pattern. It is advantageous to use infrared transmitters in combination with the array of sensors 34, eliminating the need to specifically align the transmitter and sensor to monitor a region for obstructions. Additionally, the array of sensors 34 will not be affected by ambient light or sunlight and thus do not cause false obstruction readings for the non-contact optoelectronic system.

A control module 38 is in communication with the transmitters 30 and sensors 34 disposed on vehicle door 22 and door jamb 16 by connections, schematically shown as numeral 40. The control module 38 monitors the signal interrupts detected by sensors 34 sent by transmitters 30. The control module 38 is additionally in communication with a switching mechanism 42 and drive motor 44 to control the automatic opening and closing of the vehicle door 22.

To operate the automatic vehicle door closure system, an operator activates automatic vehicle door 22 by depressing switch mechanism 42. Switch mechanism 42 signals control module 38 to activate drive motor 44. Drive motor 44 moves sliding vehicle door 22 along a track in the vehicle body towards door jamb 16. At the same time, control module 38 activates transmitters 30 and sensors 34 to monitor the horizontal forward progress of the transmitter and sensors on the door 22 toward door jamb 16. Control module 38 monitors the interrupts generated by transmitters 30 using sensors 34 to detect the presence of any obstructions between the door 22 and door jamb 16 during the forward travel of the door.

The control module 38 compares the interrupts detected by sensors 34 against stored values to determine whether an obstruction exists between the door 22 and door jamb 16. When the sensors 34 detect wavelength changes in the emitted infrared light 32, it is assumed that an obstruction is positioned between the moving door 22 and the door jamb 16. If the control module 38 determines the changes in wavelength detected by the sensors 34 do not match the stored values, then the control module 38 generates and sends a “door open” signal to the drive motor 44 to halt forward progress of door 22. The control module 38 additionally sends a signal to reverse the door travel to prevent the obstruction from being trapped or lodged between the door 22 and door jamb 16.

Referring now to FIG. 3, a second embodiment of the non-contact optoelectronic system of the present invention is shown. Non-contact optoelectronic system 50 includes a transmitter 52 mounted in the sliding vehicle door 54. The transmitter 52 includes a transmitting portion 56 extending through the vehicle door 54 which emits an infrared light signal 58. A sensor 60 is disposed on the inner surface 62 of door jamb 64 to detect the signal 58 emitted by transmitter 52.

Reflective surfaces 66, 68 are disposed on the inner surfaces of door 54 and door jamb 64. The reflective surfaces 66, 68 are provided to allow infrared light signal 58 emitted by transmitter 52 to reflect between the vehicle door 54 and door jamb 64. Reflective surfaces 66, 68 may be polished portions of the substrate of the door 54 and door jamb 64 to possess reflective characteristics. Alternatively, reflective surfaces 66, 68 of non-contact optoelectronic system 50 may be applied to the inner surfaces of door 54 and door jamb 64 as polished metal foils, sheet metal, a polymeric material or a coating having reflective characteristics. Sensor 60 detects infrared light signals 58 reflected between the door 54 and door jamb 64 emitted by the transmitter 52.

In the preferred embodiment, infrared light signals 58 emitted from the transmitter 52 on vehicle door 54 are reflected between the inner surfaces of the vehicle door and door jamb and are detected by sensor 60 on door jamb 64. However, it is also understood that transmitter 52 may be mounted on door jamb 64 while sensor 60 may be mounted on vehicle door 54. Additionally, the non-contact optoelectronic system may include a line-of-sight type system wherein the transmitter 52 emits infrared light signals 58 aimed at an array of sensors 60, or at an individual sensor 60 between the door 54 and door jamb 64.

A control module, represented schematically by block 70, is in communication with the transmitter 52 and sensor 60 through connections, generally referenced by numeral 72. The control module 70 monitors the condition of the sensor 60 at time intervals to determine whether any interruptions in the transmission of infrared light signals 58 from the transmitter 52 has been detected. Additionally, control module 66 is in communication with switching mechanism, represented schematically by block 74.

Switching mechanism 74 is manipulated by an operator to provide an automatic door opening feature, allowing an operator to open the vehicle door 54 simply by depressing the switch. The control module 70, upon receiving this signal from the switching mechanism 74 will transmit a signal to a drive motor, shown schematically as block 76, to move the vehicle door 54 forward toward door jamb 16. When the drive motor has been actuated, control module 66 will also activate non-contact optoelectronic system 50 to monitor for the presence of obstructions in the path of the vehicle door 54.

Control module 70 monitors the infrared light signals detected by sensor 60 and compares the signals to stored values to determine whether an interruption in the signal represents an obstruction between the door 54 and door jamb 64. If the control module determines that an obstruction is present between the door 54 and door jamb 64 based on an interruption of light between transmitter 52 and sensor 60, control module 70 transmits a signal to the drive motor 76 to stop the forward travel of the sliding vehicle door 54. Additionally, control module 70 may command the motor to reverse the direction of the vehicle door 54 to allow the operator to remove the obstruction from the door.

Referring now to FIG. 4, a description of the method of detecting an obstruction in an automatic vehicle door closing system is discussed in greater detail. Microprocessor of the control module performs a hardware fault detection at block 80. The microprocessor, using a software program, will pulse the transmitters during an “open” operation, or the rearward travel of the vehicle door. If the infrared light signals from transmitters are detected as signal interrupts by the sensors, the microprocessor will consider the non-contact optoelectronic system functional. If no interrupts are detected, the control module will alarm the driver via a dash light or some other means that a system fault has been detected in the non-contact optoelectronic system. This provides a failsafe mechanism to determine the existence of a fault, such as mud on the detectors or a broken transmitter.

In operation, a microprocessor receives an input 82 from switching mechanism to activate the “one-touch” automatic vehicle door closing feature. Upon receipt of this signal from switching mechanism, the microprocessor of control module sends a signal to the drive motor to initiate the forward travel and closing of the vehicle door. Control module further activates the non-contact optoelectronic system at block 84, activating the transmitter to emit an electromagnetic energy interrupt signal and the sensors to detect the signals.

The microprocessor of control module monitors interrupts from input capture ports 86 of the sensors. The microprocessor is programmed to allow the door to continue forward travel to close if an expected number of interrupts occur to indicate that the door is unobstructed until the next software cycle. The software program includes predetermined stored values for expected signal rates and times during the forward travel of the door, which are compared to the signals from the sensors. If the software program run by the microprocessor does not detect a specific number of interrupts programmed to occur in a time interval, shown at block 88, the microprocessor will assume an obstruction exists between the door and door jamb.

The microprocessor of control module will then stop the “one-touch” door closing operation by processing and sending a signal 90 to the drive motor to stop the forward travel to open the vehicle door. Additionally, the door will be opened a determined distance and will return to a manual mode of operation 92. The microprocessor may also initiate a signal to chime an alarm to warn the driver of an obstruction. If the control module senses a set number of interrupts in a time interval, shown at block 94, then the sliding vehicle door will continue its forward travel towards door jamb until the door is placed in a closed position 96.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A non-contact optoelectronic system for an automatic vehicle door closure to detect the presence of an obstruction, the system comprising:
at least one transmitter for emitting an electromagnetic energy signal;
at least one sensor for detecting the electromagnetic energy signal emitted by the at least one transmitter;
a control module in communication with the at least one transmitter and at least one sensor for monitoring and processing the signal interrupts detected by the at least one sensor to detect an obstruction between the at least one transmitter and at least one sensor, wherein the control module generates a motor control signal to stop and reverse a vehicle door upon detection of an obstruction between the at least one transmitter and at least one sensor.

2. The optoelectronic system of claim 1 wherein the control module processes the electromagnetic energy signal interrupts from the at least one sensor by comparing the interrupts against stored values to determine whether an obstruction is present in an entry area of the vehicle.

3. The optoelectronic system of claim 1 wherein the entry area of the vehicle is defined by a passage in a vehicle body, a door jamb defining an outer periphery of the passage and a vehicle door selectively positionable between an open position and a closed position adjacent the passage of the vehicle.

4. The optoelectronic system of claim 1 wherein the at least one transmitter further comprises a pair of transmitters disposed on an inner surface of the vehicle door.

5. The optoelectronic system of claim 1 wherein the at least one sensor further comprises a single sensor disposed on an inner surface of the door jamb.

6. The optoelectronic system of claim 1 wherein the at least one sensor further comprises a plurality of sensors disposed on the inner surface of the door jamb.

7. The optoelectronic system of claim 6 wherein the plurality of sensors are arranged as an array on the inner surface of the door jamb to detect signals transmitted by the at least one transmitter.

8. The optoelectronic system of claim 1 further comprising a first reflective surface disposed on the inner surface of the vehicle door and a second reflective surface disposed on the inner surface of the door jamb to reflect the emitted signal from the at least one transmitter to the at least one sensor.

9. The optoelectronic system of claim 8 wherein the first and second reflective surfaces comprise a reflective coating applied to the inner surfaces of the vehicle door and door jamb.

10. The optoelectronic system of claim 8 wherein the first and second reflective surfaces comprise a polished metal surface disposed on the inner surfaces of the vehicle door and door jamb.

11. The optoelectronic system of claim 1 wherein the electromagnetic energy signal emitted by the at least one transmitter is infrared light.

12. An automatic vehicle door closure system comprising:
an entry area for a vehicle, the entry area defined by a passage in a vehicle body, a door jamb defining an outer periphery of the passage and a vehicle door selectively positionable between an open position and a closed position adjacent the passage of the vehicle;
a drive motor operatively connected to the motor for selectively positioning the door between an open and closed position;
at least one transmitter for emitting an electromagnetic energy signal into the entry area of the vehicle;
at least one sensor for detecting the electromagnetic energy signal emitted by the at least one transmitter in the entry area of the vehicle;
a control module in communication with the at least one transmitter and at least one sensor for monitoring and processing the signal interrupts detected by the at least one sensor to sense an obstruction in the entry area of the vehicle during the closing of the vehicle door, wherein the control module generates and sends a motor control signal to the motor to stop and open the vehicle door upon detection of an obstruction between the at least one transmitter and at least one sensor in the entry area of the vehicle.

13. The vehicle door closure system of claim 12 wherein the control module compares the interrupts detected by the at least one sensor against stored values to determine whether an obstruction is present in the entry area of the vehicle.

14. The vehicle door closure system of claim 12 wherein the control module activates the at least one transmitter and at least one sensor upon receiving a signal from a switching mechanism to operate drive motor to close the vehicle door.

15. The vehicle door closure system of claim 12 wherein the at least one transmitter further comprises a pair of transmitters disposed on an inner surface of the vehicle door.

16. The vehicle door closure system of claim 12 wherein the at least one sensor further comprises a plurality of sensors disposed on the inner surface of the door jamb.

17. The vehicle door closure system of claim 16 wherein the plurality of sensors are arranged as an array on the inner surface of the door jamb to detect signals transmitted by the at least one transmitter.

21. The method of claim 19 wherein the step of emitting an interrupt signal from the at least one transmitter further comprises emitting an infrared light signal from the at least one transmitter.

22. The method of claim 19 further comprising the step of performing a hardware fault detection of the obstruction detection during the opening of the automatic vehicle door.

23. The method of claim 22 wherein the step of performing a hardware fault detection of the non-contact optoelectronic system further comprises sending a pulse of infrared light from the at least one transmitter to the at least one sensor to test the optoelectronic system.
